(19) United States
(12) Patent Application Publication
(10) Pub. No.: US 2015/0288947 A1
(43) Pub. Date: Oct. 8, 2015

(54) POSITION AND LOCATION DETECTION OF OBJECTS

(71) Applicant: Airbus DS GmbH, Taufkirchen (DE)

(72) Inventors: Ingo Ahrns, Bremen (DE); Christoph Haskamp, Bremen (DE)

(21) Appl. No.: 14/674,080

(22) Filed: Mar. 31, 2015

(30) Foreign Application Priority Data
Apr. 3, 2014 (DE) 102014005181.1

(51) Int. Cl. H04N 13/02; G06T 7/00; G06K 9/62

(52) U.S. Cl. CPC H04N 13/0203; H04N 13/0275; G06K 9/6202; G06T 7/0046

(57) ABSTRACT

A method for position and location determination of objects, particularly uncooperative objects. A 3D sensor delivers data of the target object, which are compared with target object data stored in a model database and are used both for an initial position and location estimation and for a subsequent more accurate position and location estimation of the target object. The 3D sensor, preferably a LIDAR, delivers the data relating to a sensor coordinate system in the form of a 3D point cloud, which is converted to a depth image in which each pixel receives a gray value, which corresponds to a depth within a cuboid surrounding the target object. The method for initial position and location estimation is based on 2D template matching By using depth data, three of six degrees of freedom can be eliminated, resulting in a robust and fast method for initial position and location estimation.

### CROSS-REFERENCES TO RELATED APPLICATIONS

This application claims the benefit of the German patent application No. 10 2014 005 181.1 filed on Apr. 3, 2014, the entire disclosures of which are incorporated herein by way of reference.

### BACKGROUND OF THE INVENTION

The invention relates to a method for the position and location detection of objects, particularly of uncooperative objects.

A problem of unmanned space travel is the maintenance, repair and disposal of space vehicles and satellites that are in use, insofar as this has not already been prepared during mission planning for operations of this type. A precise measurement of the relative position and the location of such a target object is necessary in order to be able to carry out these operations, so that approaching and the eventual capture of this target object can be carried out in a controlled manner. This is true in particular for target objects that are uncooperative in the sense that they are not adapted to this approach task, that is to say, in particular, also do not provide any artificial markers for supporting the navigation task and also are not location-controlled.

In this context, camera-based methods that are already known attempt to reconstruct an object to be captured on the basis of the edge profiles thereof in camera images or else in depth images. As, in this process, one is essentially concerned with methods based on three-dimensional data, these known methods often touch upon 3D point clouds, as are typically generated by 3D sensors.

Possible 3D-sensor technologies are laser-based, light-travel-time measuring sensors, which divert a laser beam fast over a scene and in the process scan the three-dimensional structure of this scene. In addition to those sensors termed LIDAR (light detection and ranging), there are further sensor types, which create 3D measurements, such as e.g., PMD cameras (photon-mixing-device), stereo-camera-based systems, light-stripe-projection sensors or similar. It is common to the known sensors in this case that they scan their environment and thus reconstruct a three-dimensional image of their environment.

Systems which use this information for determining object position and location mostly have recourse to the spatial structure of a target body as a significant feature of the target object and the position and location thereof. Most distinguishing features of the various approaches exist in the systems analyzing the data and the methods executed thereon. A detailed overview of the usual methods of object recognition and position determination on the basis of 3D data can be found e.g., in the book article “Dreidimensionales Computersehen, Gewinnung and Analyse von Tiefenbildern” [Three-dimensional computer vision, obtaining and analyzing depth images] by X. Jiang and H. Bunke, Springer Verlag, Berlin, Heidelberg, N.Y., 1997. Thus, the methods described in this article are based on the fact that initially a segmentation of a 3D point cloud is converted into a more symbolic description. That can occur e.g., in that planar surface patches are adapted to the 3D points and the sensor data are thus converted into a collection of surface elements, which functions particularly well in the case of objects that are composed of surface segments. For free-form surfaces, the segmentation must be configured in a correspondingly more complex manner. Such a use of a segmentation as pre-processing step before the actual position and location determination has the disadvantage however, that a high data density is required for a satisfactory segmentation and only a slight measurement noise is allowed.

Therefore, alternative method approaches have also already been suggested, which dispense with creating a symbolic descriptive form from such acquired data. Thus, for example, the so-called 3D LASSO technology uses a very thinly occupied 3D point cloud as an initialization step of the position and location determination and applies an approach termed polygon-aspect-hashing method, in order to achieve an initial estimation of the object position and location by means of a comparison with a model of the target object. Alternatively, a series of probabilistic approaches has become known, which can likewise be used for the position and location estimation of known objects. In these known approaches, a hypothesis of a 3D position and location is evaluated with regards to its probability with the aid of efficient voxel representations of a 3D object. With the aid of this evaluating mechanism, classical particle filters can be used, in order to determine the most likely position and location on the basis of the observed 3D point cloud.

All of these known methods are used to estimate an initial position and object location, which is sufficiently accurate, in order to be able to initialize a subsequent process of position and location tracking. In the literature, this position and location tracking is very often carried out with the aid of the algorithm termed ICP (iterative closest point). This algorithm also encodes the object model as a point cloud and determines, starting from an initial position and location estimation, the in each case closest neighbors of both 3D point clouds, and in this manner one obtains a list of corresponding 3D point pairs. A transformation matrix, which brings the two point clouds closer to one another, is then established therefrom with the aid of the least squares method. After a few iterations, the two point clouds are optimally brought to concurrence, wherein the initial start position is sufficiently close to the actual solution. The chain of individual transformations during the iteration process then gives the position and location sought. In addition, further variants exist, such as e.g., representing the model as a surface model and then comparing the 3D points with the closest plumb foot points on the surface model.

### SUMMARY OF THE INVENTION

It is an object of the invention to design a method of the type mentioned at the beginning in such a manner that for a target object floating freely in space, e.g., a satellite, the position and location of an object, which is assumed to be known per se, can be established with the aid of a sensor, which acquires a collection of 3D points distributed over a field of vision of sufficient size.

The invention achieves this object by means of a method for position and location determination of objects with the aid of a 3D sensor and an analysis method adapted thereto, wherein the method is broken down into 3D data acquisition, an initial position and location estimation and also a subsequent tracking of the target object.

In this case, the method according to the invention achieves a navigation task, as arises during approach or docking between two space vehicles. The basic idea thereof comprises using the spatial structure of the target object as a whole as the fundamental feature, which gives information about the position and location of the target object. In this case carrying out a segmentation or feature extraction of the sensor data, which convert the raw data into a symbolic descriptive form, is dispensed with. Instead, the method according to the invention follows an approach, which is based exclusively on data close to the signal and as a result does not place particularly high requirements on data density and data quality, i.e., on minimizing measurement noise. According to the invention, the solution is broken down into an initializing stage and a subsequent tracking stage. According to the invention, for the tracking stage, recourse is had to previously existing technology, while the method according to the invention chooses a simple but robust approach for initialization of the rough position and location of the target object without the existence of prior knowledge about the position and location, which approach is based on the template matching of 2D image processing that is known per se, and which, thanks to the use of depth images generated from the 3D point clouds, reduces the search space across three dimensions.

The method according to the invention for position and location estimation of a target object in this case has numerous advantages compared to the already-known methods. Due to the closeness of the suggested method to the original data—without any segmentation of the 3D data being required—a very robust approach results, which does not place high requirements on data quality, i.e., on point density and measurement noise. Thus, the method according to the invention has the advantage compared to the otherwise suggested methods that it does not require a special form of point distribution. A main difference from the already-known methods in this case comprises the manner in which the initial estimation of the object position and the object location takes place. To this end, existing principles of 2D image processing are applied to the special case of 3D point clouds and a method is used, which is orientated on the template matching of 2D image processing. Owing to the presence of 3D data, in the method according to the invention, translation invariance and scale invariance can nonetheless be realized to the greatest extent possible. According to the invention, a search only takes place for the possible orientations, wherein many hypotheses can already be excluded by means of a very simple criterion, i.e., the size of the cuboid.

Tracking the target object takes place after the initialization or in knowledge of the position and location from a tracking step that has already taken place with the aid of the ICP method, which is known per se, or one of the variants thereof. Thereafter, the model database comprises a collection of geometric elements, which can be used for the ICP algorithm, e.g., a collection of 3D points, spatial straight line segments or spatial surface segments, such as triangles for example. These data are derived from a CAD representation of the target object and are, if appropriate, optimized and adapted with regards to the degree of detail of the accuracy to be achieved and the available computing capacity.

While object tracking using an ICP variant therefore substantially corresponds to current methods, the following special conditions apply for the method for position and location estimation:

1. The object is known and can be saved as a model.

2. In the case of space uses in particular, but also in the case of the uses of underwater robotics, the object is singular in the field of vision of the sensor, without background objects being present in the 3D data at the same time.

3. The sensor delivers 3D data of the object, which contain the spatial distance from the object in particular.

These three properties are used for the method according to the invention, which was developed from a standard approach of 2D image processing and which is termed 3D template matching In 2D image processing, template matching is referred to as a method, which detects a rectangular image section, the search window or the template, in a larger image. Other methods are the sum of the squared differences, what is known as block matching or the SSD method, or else the calculation of normalized cross correlation. A large problem of template matching in 2D image processing is the vulnerability with respect to illumination changes, i.e., a lack of illumination invariance, and also a lack of rotation and scaling invariance. Thus, the use of template matching for 2D camera images turns out to be practical, as the search space would become too large and at the same time, the lack of illumination invariance would not lead to a robust method.

However, under the features of the method according to the invention, the sensor provided according to the invention delivers 3D point clouds, which are independent of external illumination conditions and which image a complete or partial spatial representation of the target object. The lack of scaling invariance in 2D image processing can be compensated in particular by means of knowledge of the spatial depth to the object, so that the search space for a vision-based approach, such as template matching, can be reduced drastically compared to the 2D case, and as a result leads to a simple, very robust approach, which is simple and fast to realize.

The following documents are to be mentioned from the prior art: DE 60 023 447 T2 deals with the detection of the position and location of a face and in the process uses features, which were previously derived from known data, which is not the case in the method according to the invention. DE 10 2011 100 927 A1 deals with position and location estimation of a vehicle on the basis of laser distance measurements. Although a similar measurement principle to the one used in the method according to the invention is used here for the acquisition of 3D point clouds, the essential difference comprises the fact that in this known method, only three to six degrees of freedom have to be determined, as vehicles only move on one plane. DE 10 2011 075 335 A1 likewise suggests a computer-assisted method for determining an object position and location.

This takes place via the use of camera images however and the extraction of features from these camera images, which are compared with the features of a database.

DE 10 2008 019 795 A1 contains a method for adapting an object model to a 3D point cloud. In contrast with the method according to the invention, this known method uses a stereo method for reconstructing depth data and in the process attempts to prevent or to improve errors in the stereo reconstruction. Furthermore, cluster technologies are used, which are not used in the method according to the invention. Furthermore, DE 10 2006 036 346 B4 describes a method for automated 3D object recognition and location determination, which is based on the assumption that a target object comprises diverse regular geometric bodies, such as e.g., cuboids or cylinders. Finally, DE 10 2006 036 345 A1 describes a method, which proceeds from similar assumptions and also DE 69 705 052 T2 is aimed at a navigation aid between two moved bodies, which is based on a method based on signal travel time.

### BRIEF DESCRIPTION OF THE DRAWINGS

The method according to the invention shall be explained in more detail in the following on the basis of the drawing. In the figures

FIG. 1 shows the principal structure of a system for LIDAR-based position and location estimation,

FIG. 2 shows the mode of action of a system for LIDAR-based position and location estimation,

FIG. 3 shows the corner points of a polyhedron, which the viewing directions for the calculation of the reference views span; two different resolutions are illustrated in the figure,

FIG. 4 shows the principle of the comparison of the current view with reference views,

FIG. 5 shows the principle of the comparison with a reference view in the case of a partial object view,

FIGS. 6a and 6b show errors in the position and location estimation for a satellite rotating at approx. 4°/s about the longitudinal axis,

FIG. 7 shows the adaptation of the 3D point cloud points to the surface model of the target object after the application of 3D template matching and the point to surface ICP, and

FIG. 8 shows the adaptation of the 3D point cloud to the surface model of the target object in the case of a larger distance from the target object and a complete view.

### DETAILED DESCRIPTION OF THE PREFERRED EMBODIMENTS

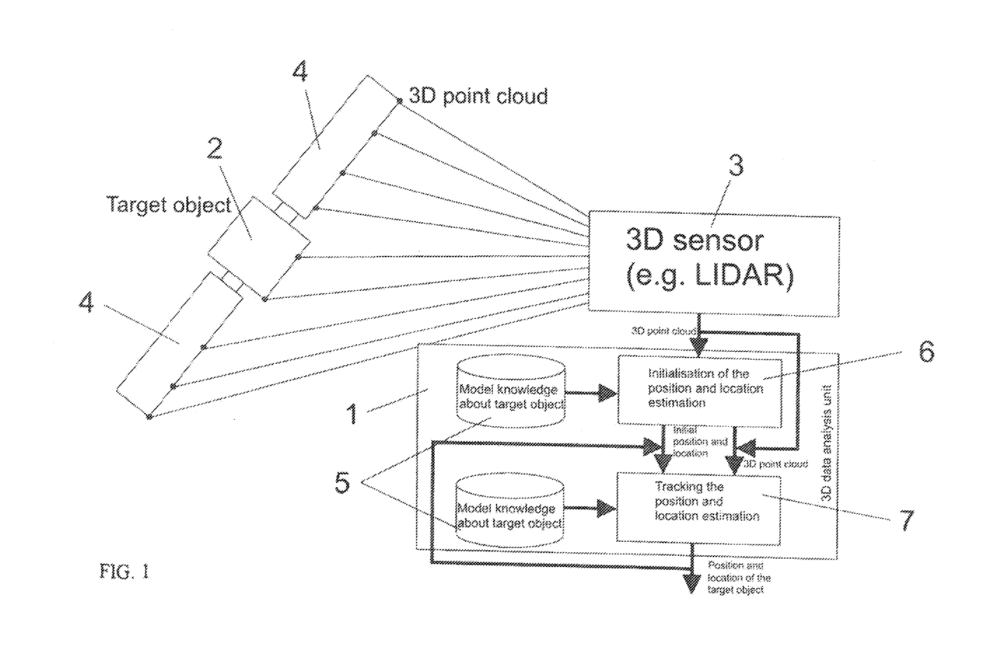

The workflow of a position and location estimation using the method according to the invention, illustrated in FIG. 1, is the following:

A 3D data analysis unit 1 hosts a model database 5, which contains the model knowledge about a target object 2 in two forms.

A 3D sensor 3 acquires a 3D point cloud 4 of the target object 2, which is located inside the field of vision of the sensor 3. The sensor 3 can in this case be any desired 3D sensor, as long as it determines a number of 3D points, which do not necessarily have to be close together, but rather can also have gaps.

The method for initial position and location estimation initially undertakes a first rough position and location estimation 6 of the target object 2 by means of the comparison of the thus-obtained 3D data points and the model representation, which estimation achieves an accuracy of approximately 10° with respect to the location in all three spatial angles and which achieves an accuracy of approximately 3%-5% of the object dimensions with respect to the position of the target object 2.

The subsequent method for tracking the position and location estimation 7 initially uses the result of the previous rough position and location estimation 6 of the target object 2 and refines the position and location estimation 7 while constantly updating the 3D point cloud 4. Should the object tracking have lost the target object 2 one time, then initial position and location estimation 6 is reactivated.

The model database 5 represents the knowledge about the target object 2 in duplicate form, so that it is optimally available for both processing stages, i.e., prepared both for the initialization 6 and for the tracking 7 of the target object 2.

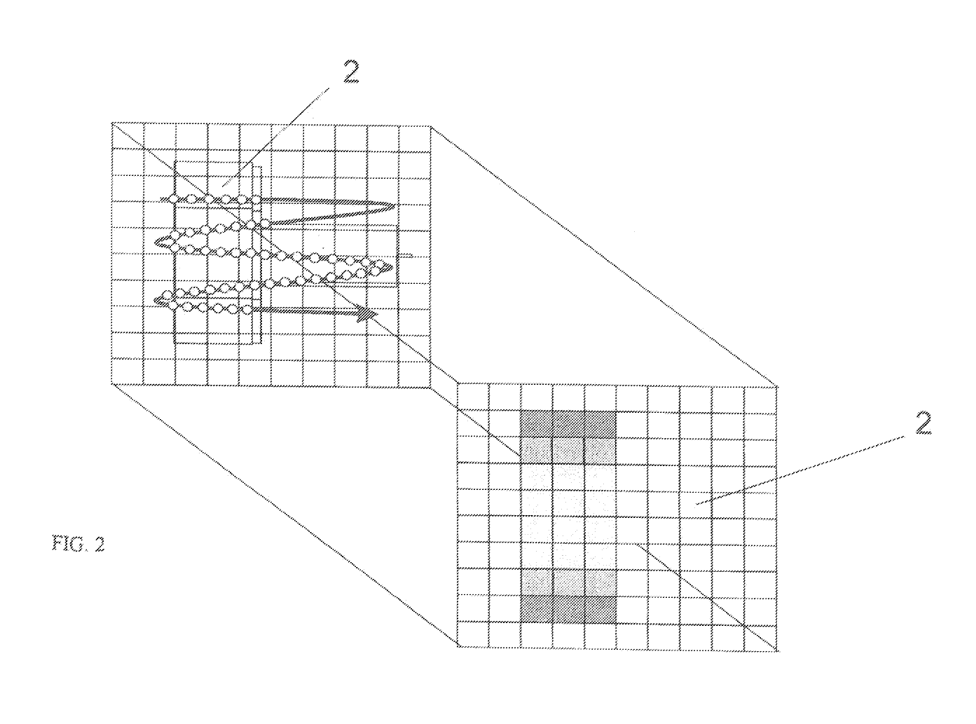

The 3D sensor 3 delivers more or less dense 3D data in relation to a sensor coordinate system. This 3D point cloud 4 can be converted to give a depth image, in which each pixel receives a gray value, which corresponds to a depth within a cuboid surrounding the object. The spatial focus of all 3D data is identified using the cuboid center, whereby a spatial search, as is the case for example in the case of 2D template matching, can be dispensed with in the case of a complete view. The conversion of the 3D data into the template, i.e., into the current view of the template object 2, is illustrated by FIG. 2 and corresponds to an orthographic projection of the sensor measurements with a gray value encoding of the depth information for each pixel.

For each viewing direction of the polyhedron, the rotation of the target object 2 about the line of sight is scanned with a certain angular resolution, so that for each of these reference views, a template, as shown in FIG. 2, is created and can be stored in a database. The size of the reference template can generally turn out to be very small if the target object has sufficiently geometric structures.

During a trial of the method, an object with a size of approximately 2 meters was represented with reference templates with a size of 30×30 pixels. In addition to each reference view, the offset between the origin of the target object 2, i.e., the body coordinate system, and the focus that has been determined is saved, which offset is displaced into the center of the cuboid for the orthographic projection. Taking account of this offset make it possible during the position search to relate the position found to the inherent reference system of the target object 2 again. Likewise saved is the effectively used width, height and depth in the cuboid.

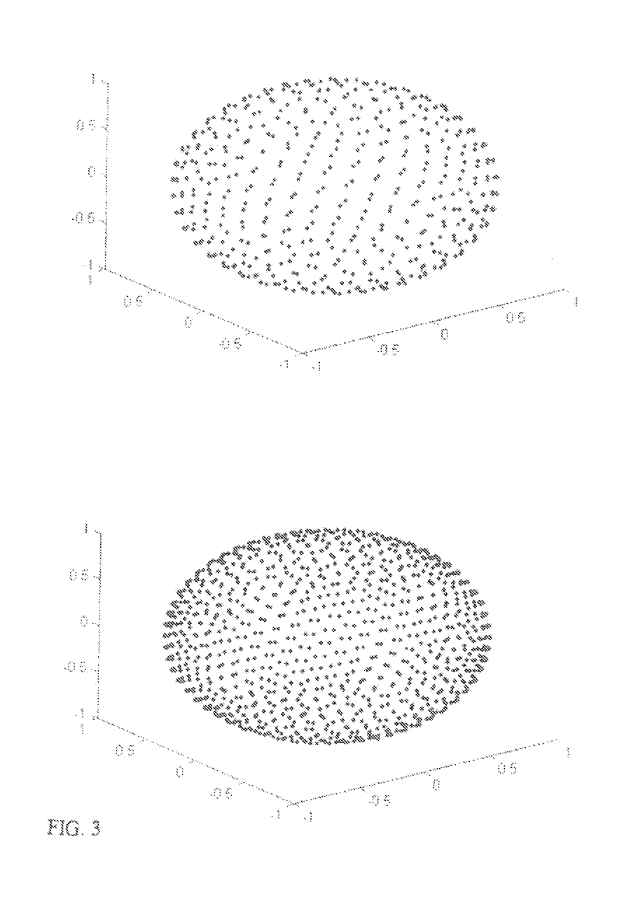

Owing to the orthographic projection, which only necessitates the maximum dimensions of the object for the definition of the cuboid and template size, scaling invariance can be achieved in this manner. By normalizing the view onto the focus of the 3D point cloud, position invariance is also achieved in the case of a complete object view. Thus, three of the six degrees of freedom sought can be removed already. The degrees of freedom of rotation remain, which correspond to the object position. These cannot be resolved any more, unless the object has certain symmetries. The method according to the invention solves this problem, in that various views from different observation directions of the object in the form of the template mentioned are saved in the model database 5 with a certain angular resolution. The various views can be removed for two of the three degrees of freedom of rotation of the position of a unit ball about the zero point, wherein the connecting line of each point to the zero point defines a line of sight and therefore two of the three degrees of freedom of rotation. The image according to FIG. 3 shows this for two different angular resolutions.

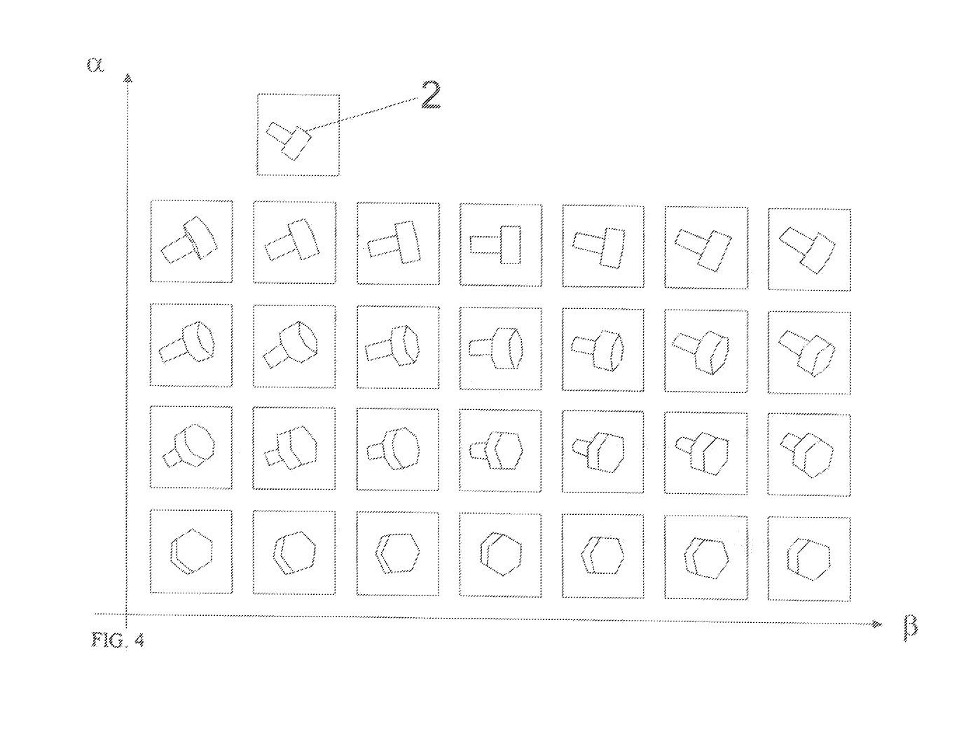

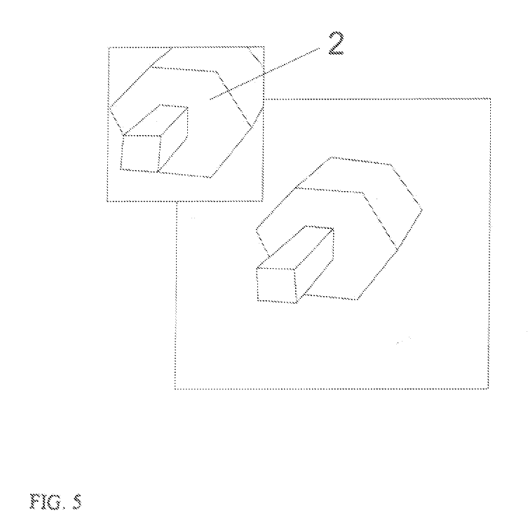

The actual position and location estimation 7 takes place in that, as illustrated in FIG. 4, the current view, obtained from the acquired 3D sensor data, is compared with all views of the model database 5. In this case, this schematic sketch only shows two of the three degrees of freedom of rotation. The effective width and height used within the cuboid are called upon as first comparison criterion. Should the current view demand a larger width or height than the reference view, then this may not be the view sought and the hypothesis can be discarded. Should the sizes match approximately, then both templates can be compared by means of simple pixel-by-pixel comparison, e.g., according to the SSD criterion. Should the current view be smaller than the reference template currently being considered, by contrast, then it cannot be rejected a priori that the current view could also be only a partial view of the target object 2, for example according to FIG. 5. By contrast, the reference images of the database 5 always contain complete object views.

In this case, a spatial correlation or calculation of the SSD criterion is additionally necessary for all offset points within the reference image, for which the current view fits completely into the reference image. The highest correlation or the lowest SSD value of this search give the comparison value for the current view with the reference image. The results are then normalized, so that the absolute size of the current view is of no importance.

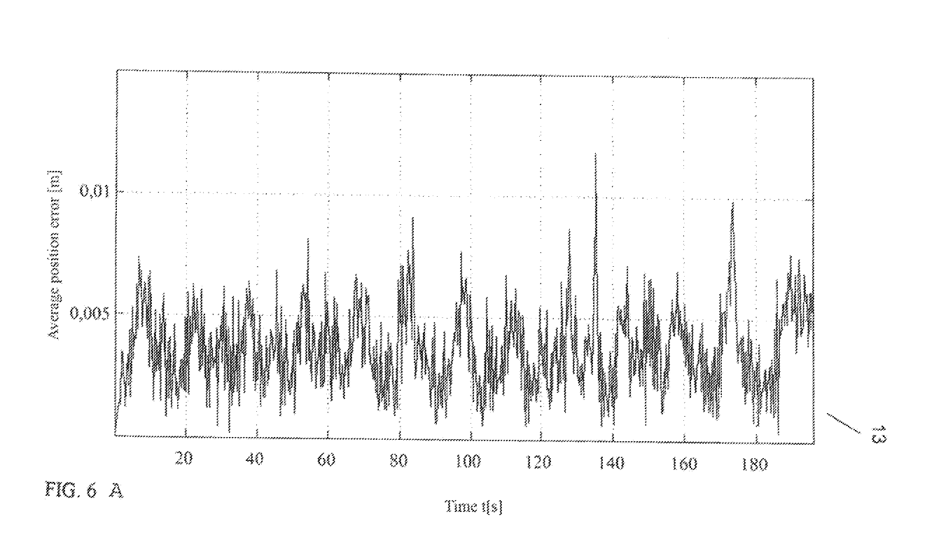

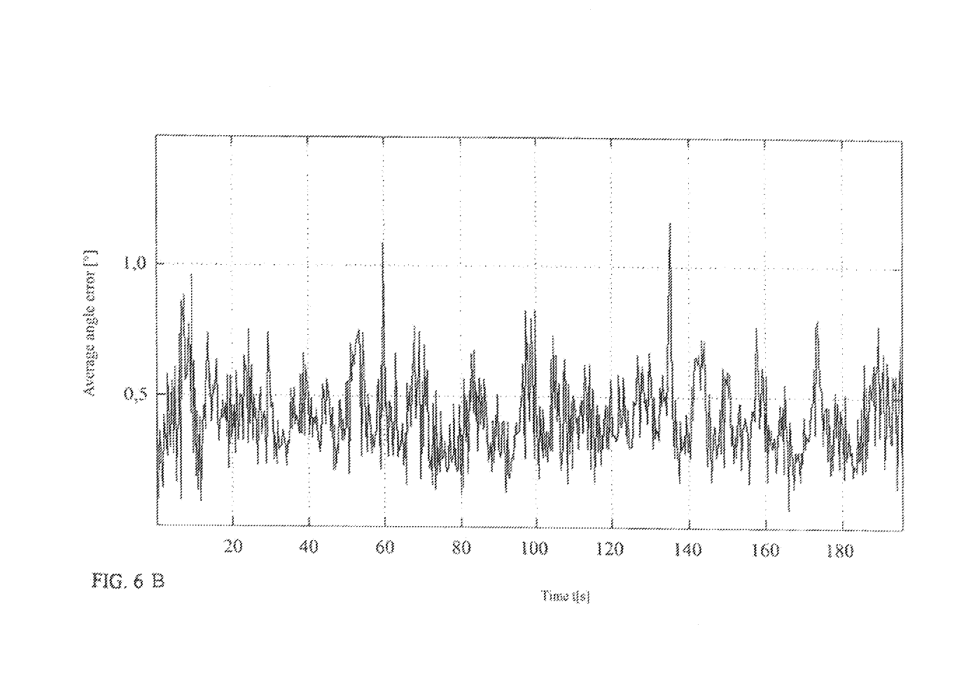

Finally, in FIGS. 6 to 8, the performance of the method is demonstrated on the basis of a real test structure, in which a model of a satellite has been used in a robotic test unit, which simulates the approach of space vehicles. In this case, the method was tested with a 3D LIDAR for the use case of relative navigation in an approach of a space vehicle to a known tumbling and uncooperative target satellite. For this purpose, numerous test trajectories were travelled for simulating an approach to these tumbling satellites, and the measured data of the 3D LIDAR for a position and location estimation of the target object 2 created during this approach were compared with the reference measurements of the test unit. The system concept was tested with a 3D LIDAR, which has resolved the scene at approx. 3 Hz and a sinusoidal scanning with approx. 40 lines and 150 measuring points per line.

The suggested approach is most similar to the “3D LASSO” approach mentioned at the beginning Performance comparisons between 3D template matching and the 3D LASSO method were able to show a clear increase in accuracy. FIG. 6 shows the accuracies achieved with the approach according to the invention for a satellite with a size of approximately 2 m, specifically illustrated in FIG. 6a as average position error in meters and in FIG. 6b as average angle error in angular degrees.

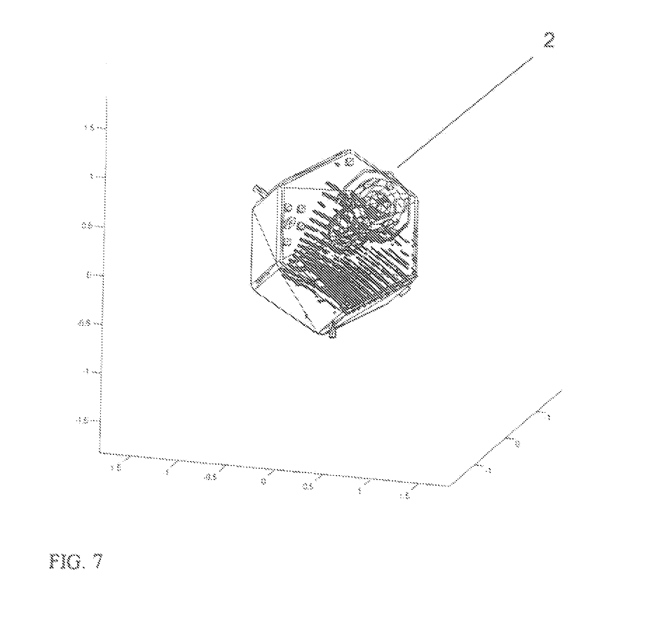

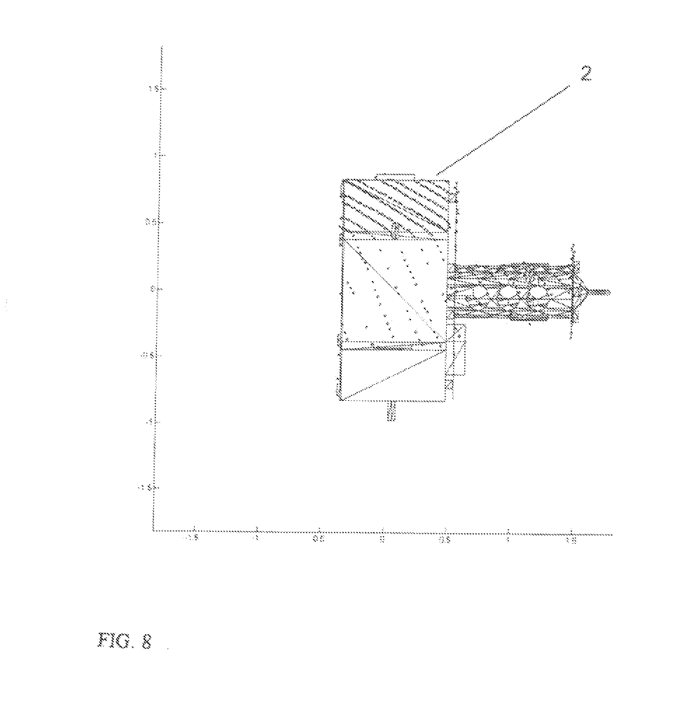

FIG. 7 shows the adaptation of the 3D point cloud to the surface model of the target object 2 according to the use of the 3D template matching and the point to surface ICP. The target object 2 is located close to the sensor in this case, so that only a partial view results. FIG. 8 finally shows the adaptation of the 3D point cloud to the surface model of the target object 2 at a larger distance from the target object 2 and in the case of a complete view.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for position and location determination of objects, comprising
delivering data of a target object with a 3D sensor,
comparing the delivered data with data of the target object stored in a model database, and
using the delivered data for an initial position and location estimation and a subsequent more accurate position and location estimation of the target object.

2. The method according to claim 1, wherein the 3D sensor delivers data relating to a sensor coordinate system in the form of a 3D point cloud, which 3D point cloud is converted to a depth image in which each pixel receives a gray value, the gray value corresponding to a depth within a cuboid surrounding the target object.

3. The method according to claim 1, wherein the sensor is a 3D LIDAR.
